(19) United States
(12) Patent Application Publication
(10) Pub. No.: US 2020/0309552 A1
(43) Pub. Date: Oct. 1, 2020

(54) METHOD AND APPARATUS FOR DETERMINING A RIDE HAILING PICKUP POINT BASED ON STEP COUNT INFORMATION

(71) Applicant: HERE GLOBAL B.V., Eindhoven (NL)

(72) Inventors: Sanket PALANDE, Maharashtra (IN); Shaikh HaqueMobassir IMTIYAZ, Maharashtra (IN); Vinish NADAR, Koparkhairane (IN); Tejas THORAT, Old Panvel (IN)

(21) Appl. No.: 16/371,961

(22) Filed: Apr. 1, 2019

(51) Int. Cl. G01C 21/34; G01C 21/36; G06Q 50/30

(52) U.S. Cl. CPC G01C 21/3476; G06Q 50/30; G01C 21/3617

(57) ABSTRACT

An approach is provided for determining a POI ride hailing pickup point based on step count information that minimizes user pickup wait time. The approach involves determining a location of a user of a ride hailing service. The approach also involves determining at least one pickup point for the ride hailing service based on the location. The approach further involves calculating a path from the location to the at least one pickup point with respect to a step count, wherein the step count indicates an estimated number of steps to be taken by the user to reach the at least one pickup point. The approach further involves providing a representation of the step count.

### BACKGROUND

Providing navigation support to users and operators of ride hailing services is an important function for map service providers. If an end user is unfamiliar with a large point of interest (POI) (e.g., an apartment complex, a shopping mall, an airport terminal, etc.), she or he may not know which entry-exit point of the POI is the most convenient from her or his current location (e.g., in terms of walking distance) to designate as the ride hailing service pick up point. In addition, global positioning system (GPS) coordinates of most accurate GPS versions are accurate only within a few meters (e.g., 2-5 meters). Therefore, even if a user is standing within a POI or moves just a few meters in one direction or the other, a ride hailing service operator may believe that a user is at a different location within the POI than her or his actual location or that the user is at a different POI all together. The lack of familiarity with large POIs and the inability to accurately localize users at such POIs can inconvenience both users and operators of ride hailing services alike (e.g., by increasing wait times, fuel consumption, costs, etc.). Accordingly, service providers face significant technical challenges to facilitate greater convenience for both users and operators of ride hailing services.

### SOME EXAMPLE EMBODIMENTS

Therefore, there is a need for determining a ride hailing pickup point at a POI that minimizes wait times for both users and operators of ride hailing services.

According to one embodiment, a computer-implemented method for a determining a ride hailing pickup point based on step count information comprises determining a location of a user of a ride hailing service. The method also comprises determining at least one pickup point for the ride hailing service based on the location. The method further comprises calculating a path from the location to the at least one pickup point with respect to a step count, wherein the step count indicates an estimated number of steps to be taken by the user to reach the at least one pickup point. The method further comprises providing a representation of the step count.

According to another embodiment, an apparatus for determining a ride hailing pickup point based on step count information comprises at least one processor, and at least one memory including computer program code for one or more computer programs, the at least one memory and the computer program code configured to, with the at least one processor, cause, at least in part, the apparatus to determine a location inside a POI of a user of a ride hailing service. The apparatus is also caused to determine at least one pickup point for the ride hailing service based on the location. The apparatus is further caused to calculate a path from the location to the at least one pickup point with respect to a step count, wherein the step count indicates an estimated number of steps to be taken by the user to reach the at least one pickup point. The apparatus is further caused to determine a recommended entry-exit point of the POI based on a minimum number of the step count.

According to another embodiment, a non-transitory computer-readable storage medium for determining a ride hailing pickup point based on step count information carries one or more sequences of one or more instructions which, when executed by one or more processors, cause, at least in part, an apparatus to determine a location of a user of a ride hailing service. The apparatus is also caused to determine at least one pickup point for the ride hailing service based on the location. The apparatus is further caused to calculate a pedestrian path from the location to the at least one pickup point with respect to a step count, wherein the step count indicates an estimated number of steps to be taken by the user to reach the at least one pickup point. The apparatus is further caused to provide a representation of the step count in a user interface of the ride hailing service.

According to another embodiment, an apparatus for determining a ride hailing pickup point based on step count information comprises means for determining a location of a user of a ride hailing service. The apparatus also comprises means for determining at least one pickup point for the ride hailing service based on the location. The apparatus further comprises means for calculating a path from the location to the at least one pickup point with respect to a step count, wherein the step count indicates an estimated number of steps to be taken by the user to reach the at least one pickup point. The apparatus further comprises means for providing a representation of the step count.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining a ride hailing pickup point at a POI based on step count information, according to one embodiment;

FIG. 2 is a diagram of the components of a routing platform, according to one embodiment;

FIG. 3 is a flowchart of a process for determining a ride hailing pickup point at a POI based on step count information, according to one embodiment;

FIG. 4 is a flowchart of a process for determining a ride hailing pickup point at a POI based on a change in user step count information or traffic, according to one embodiment;

FIGS. 5A through 5E are diagrams of example location-based user interfaces for determining a ride hailing pickup point at a POI based on step count information, according to one embodiment;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset or vehicle or part thereof) that can be used to implement an embodiment.

### DESCRIPTION OF SOME EMBODIMENTS

Examples of a method, apparatus, and computer program for determining a ride hailing pickup point at a POI based on step count information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

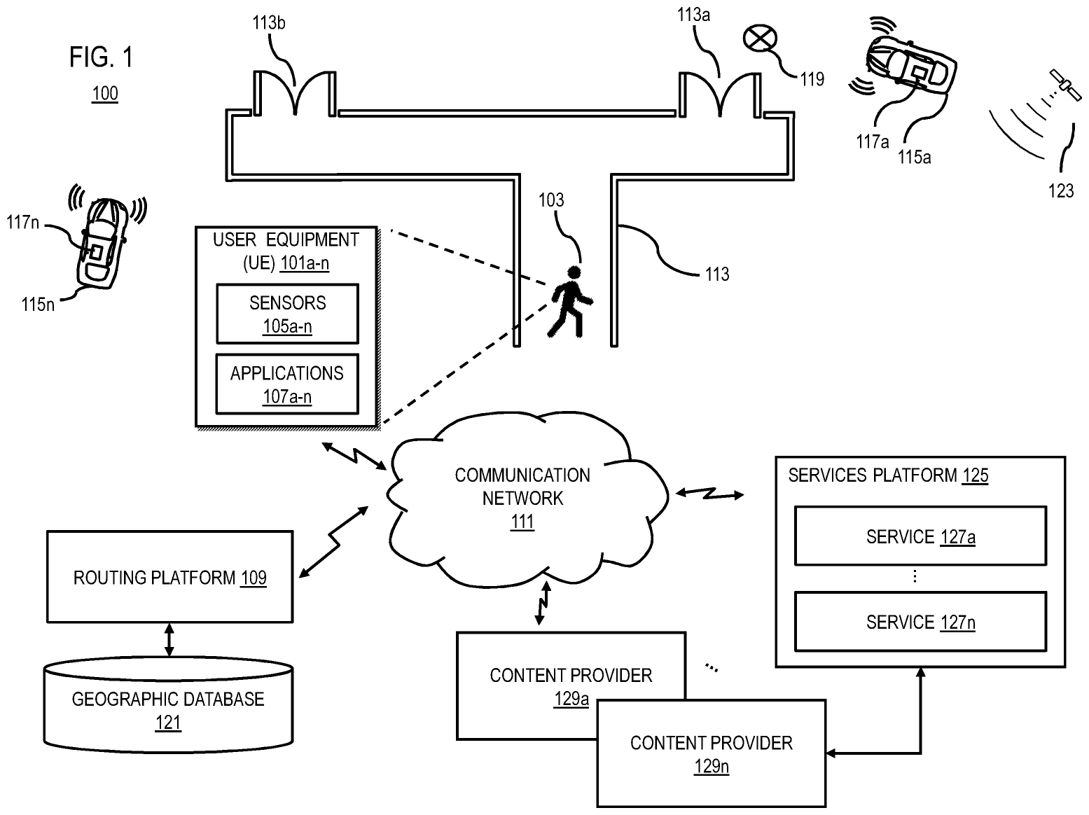

FIG. 1 is a diagram of a system capable of determining a ride hailing pickup point at a POI based on step count information. For example, the pickup point can minimize wait time for both users and operators of ride hailing services alike. As described above, providing navigation support for end users and operators of ride hailing services (e.g., owners and/or drivers) is an important function for map service providers. In general, both users and operators seek to minimize the waiting time or delay in being picked up by a ride hailing service or picking up a user, respectively. In one example use case, a user may want to book a ride hailing vehicle (e.g., a cab) using a ride hailing service application on her or his user device (e.g., a mobile phone or smartphone) while shopping inside a large indoor shopping mall complex. For example, the user may be finished or close to being finished shopping and wants to minimize the wait time to get home with her or his purchases.

In a current scenario, a map on the user's device may display potential pickup points within a POI. However, large POIs (e.g., an apartment complex, an airport terminal, a stadium, a museum, etc.) often have multiple entry-exit points and a user is likely to have a difficult time deciding which of the possibilities is the most convenient for designating as the ride hailing pick up point given her or his location, especially where the user is unfamiliar with the POI. For example, an entry-exit point may appear close to the user on the map (i.e., appears as a promising potential pickup point), but in fact is on a different level of the POI or the entry-exit point may be inaccessible to a ride hailing service (e.g., a fire exit).

Current GPS systems or versions may also be unable to recommend the most convenient entry-exit point to a user since GPS coordinates are often accurate only within a few meters (e.g., 2-5). Thus, even if a user is standing within the POI or moves just a few meters in one direction or the other, a ride hailing service operator (e.g., a driver) may attempt to pick up the user at a different location at the POI or possibly at a different POI all together. As a result, a driver of a ride hailing vehicle may have to waste time and fuel driving around looking for the actual location and/or the user. In some instances, a driver may have to pull over or even park the vehicle to contact the user (e.g., via phone or text) causing additional delay and inconvenience. Further, inaccurate localization may cause a ride hailing system or operator to inaccurately switch pickup assignments among nearby ride hailing vehicles. In each instance, the pickup wait time unnecessarily increases, causing an inconveniencing for both users and operators alike.

To address these technical problems, a system 100 of FIG. 1 introduces a capability to determine a POI ride hailing pickup point based on step count information, according to one embodiment. In one embodiment, the system 100 of FIG. 1 may include one or more user equipment (UE) 101a-101n (also collectively referred to herein as UEs 101) (e.g., a mobile device, a smartphone, etc.) associated with a user 103. In one embodiment, the UEs 101 include one or more device sensors 105a-105n (also collectively referred to herein as device sensors 105) (e.g., GPS sensors) and one or more applications 107a-107n (also collectively referred to applications 107) having connectivity to a routing platform 109 via a communication network 111.

In one embodiment, the system 100 determines that a user 103 is searching for a ride hailing service (e.g., to get home) via an application 107 (e.g., a mapping application, a ride hailing booking or reservation application, etc.) while inside a POI 113. By way of example, a POI 113 in this instance is a POI that is large enough to have at least two entry-exit points 113a and 113b (e.g., an apartment complex, a shopping mall, an airport terminal, a stadium, a museum, etc.) such that a user 103 may likely be challenged to know which exit-entry point is the most convenient for designating as the ride hailing pickup point relative to her or his current location (e.g., exit 113a).

In one instance, the ride hailing service includes one or more vehicles 115a-115n (also collectively referred to as vehicles 115) (e.g., a cab) that are configured with one or more vehicle sensors 117a-117n (also collectively referred to as vehicle sensors 117) and have connectivity to the routing platform 109 via the communication network 111. In one embodiment, the vehicles 115 are standard transport vehicles (e.g., cars, vans, trucks, etc.) that can be used to transport users. In one instance, the vehicles 115 are autonomous or semi-autonomous transport vehicles that can sense their environments and navigate without driver or occupant input via the vehicle sensors 117. Although the vehicles 115 are depicted as automobiles, it is contemplated that the vehicles 115 may be any type of transportation capable of picking up and transporting a user between two points.

In one embodiment, the system 100 calculates the step count or actual path that the user 103 needs to cover from her or his location within the POI 113 to access the one or more entry-exit points of the POI (e.g., exits 113a and 113b) so that the user 103 may access a ride hailing vehicle 115 (e.g., vehicle 115a) at the designated pickup point 119. In one instance, the system 100 calculates the actual path based on indoor map data, historic human traffic data within the POI 113, etc. In one embodiment, the system 100 retrieves actual path data from information or data stored in or accessible via a geographic database (e.g., the geographic database 121).

In one instance, the system 100 can render or show the user 103 (e.g., via a mapping application 107) the exit of the POI 113 (e.g., exit 113a) that will require the user 103 to take the least number of steps to reach the exit and the pickup point 119 from her or his current location. In one embodiment, the system 100 can also provide the user guidance (e.g., step-by-step guidance) via an application 107 (e.g., a mapping application) so that the user 103 can proceed through the POI 113 entry-exit point (e.g., exit 113a) to the ride hide hailing pick up 119 and be picked up by the ride hailing vehicle 115 (e.g., vehicle 115a) without any hassle or delay.

In one embodiment, the system 100 can also share or transmit the recommended pickup point to a ride hailing vehicle 115 (e.g., vehicle 115a). In one instance, the system 100 can provide the recommended pickup point 119 via a UE 101 (e.g., a mobile device) associated with the driver of the vehicle 115 or via a UE 101 such an embedded navigation system. By sharing the recommended pickup point 119 to a ride hailing service operator and/or nearby ride hailing vehicles 115, it is contemplated that the system 100 can also reduce pickup wait times for operators attempting to reach user pickup points (e.g., pickup point 119), which can improve fuel consumption and costs and facilitate greater operational convenience.

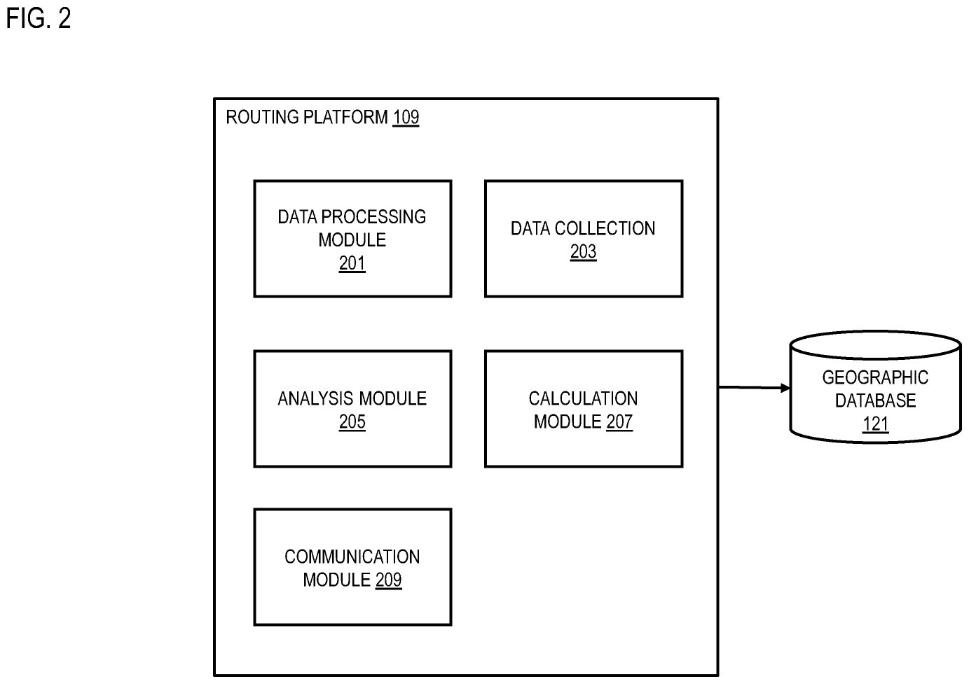

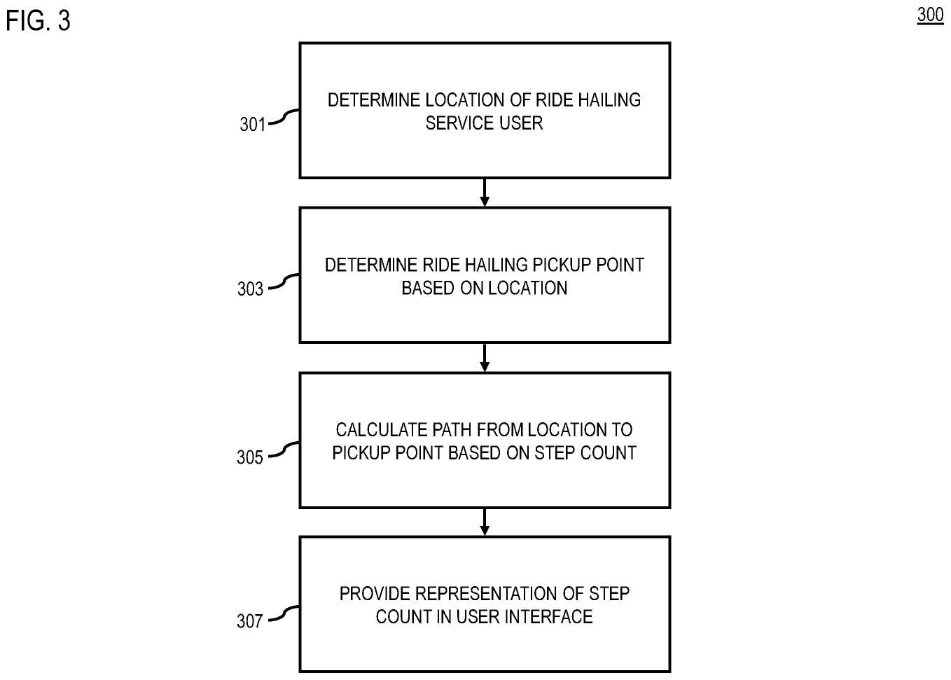

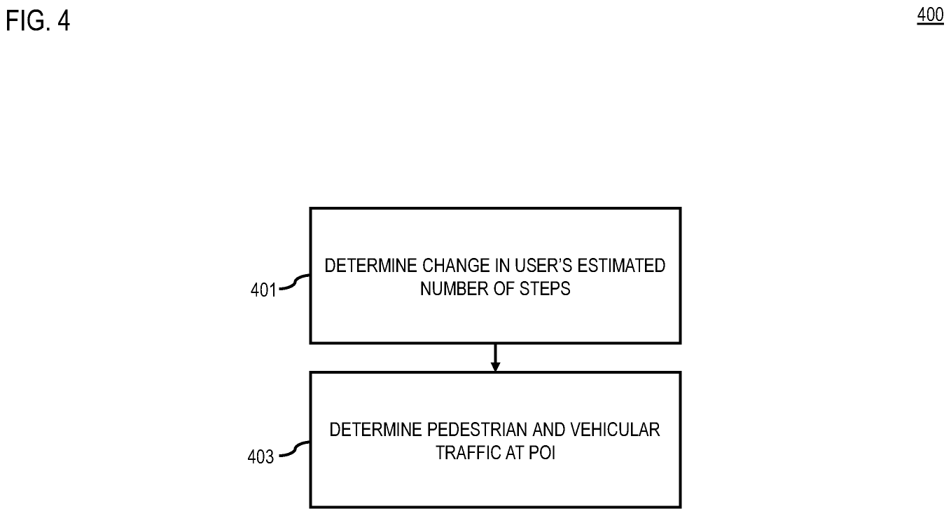

FIG. 2 is a diagram of the components of the routing platform 109, according to one embodiment. By way of example, the routing platform 109 includes one or more components for determining a ride hailing pickup point (e.g., at a POI) based on step count information. It is contemplated that the functions of these components may be combined in one or more components or performed by other components of equivalent functionality. In one embodiment, the routing platform 109 includes a data processing module 201, a data collection module 203, an analysis module 205, a calculation module 207, and a communication module 209, with connectivity to the geographic database 121. The above presented modules and components of the routing platform 109 can be implemented in hardware, firmware, software, or a combination thereof. Though depicted as separate entities in FIG. 1, it is contemplated that the routing platform 109 may be implemented as a module of any of the components of the system 100. In another embodiment, the routing platform 109 and/or one or more of the modules 201-209 may be implemented as a cloud-based service, local service, native application, or combination thereof. The functions of the routing platform 109 and/or the modules 201-209 are discussed with respect to FIGS. 3 and 4 below.

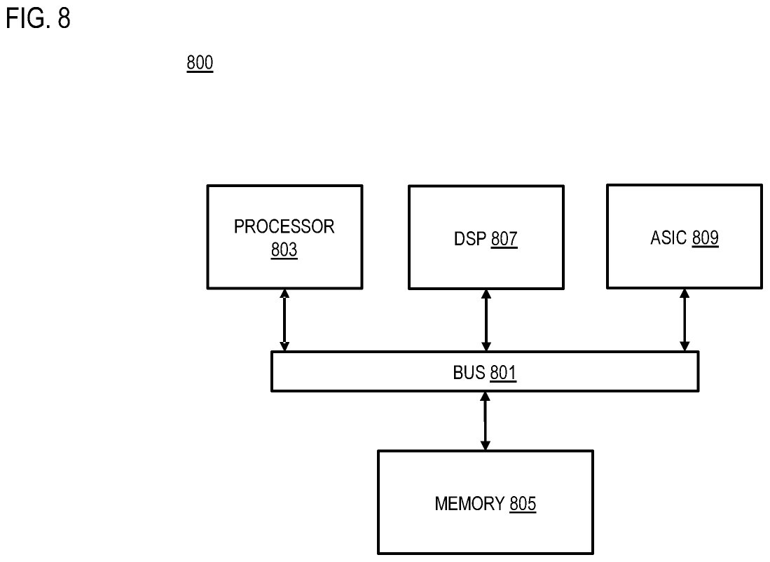

FIG. 3 is a flowchart of a process for determining a ride hailing pickup point based on step count information, according to one embodiment. In various embodiments, the routing platform 109 and/or the modules 201-209 may perform one or more portions of the process 300 and may be implemented in, for instance, a chip set including a processor and a memory as shown in FIG. 8. As such, the routing platform 109 and/or modules 201-209 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the data processing module 201 determines a location of a user of a ride hailing service. In one embodiment, the data processing module 201 can determine the location of the user based on a position (e.g., latitudinal/longitudinal coordinates, GPS coordinates, etc.) of a UE 101 (e.g., a mobile device, a smartphone, etc.) associated with the user. In one instance, the data processing module 201 can determine the position of a UE 101 based on one or more wireless connections. For example, the wireless connection may be between a UE 101 and one or more wireless fidelity (WiFi) routers positioned throughout a POI; between a UE 101 and one or more GPS satellites (e.g., satellites 123); or between a UE 101 and one or more other UEs 101 within a POI at a given time (i.e., an ad hoc peer-to-peer network). In one embodiment, where one or more wireless connections may be temporarily unavailable (e.g., the user is near or obstructed by a “blind” spot), the data processing module 201 can determine the position of a UE 101 based one or more live maps (e.g., associated with an application 107) stored on the UE 101. By way of example, the data processing module 201 may determine the location of the user based on an initiation of a search for a ride hailing service using an application 107 (e.g., a mapping application, a routing application, a ride hailing booking or reservation application, or a combination thereof).

In one embodiment, the analysis module 203 can further determine that the user is located inside a POI. In this instance, a POI refers to a large structure that has more than one entry-exit point that is accessible by a ride hailing service (e.g., an apartment complex, an airport terminal, a shopping mall, a stadium, etc.). Further, a user is likely to be uncertain while inside the POI as to which entry-exit would be the most convenient for designating as the ride hailing pickup point. In one embodiment, the analysis module 203 can determine that the user is located inside a POI by comparing the position of the UE 101 (e.g., GPS coordinates) against any known POI coordinates that are stored in or accessible via the geographic database 121.

In one instance, the data collection module 203 determines at least one entry-exit point of the POI. By way of example, the data collection module 203 can determine the number and/or location of each entry-exit point of the POI based on information or data relative to the POI stored in or accessible via the geographic database 121 (e.g., indoor maps, external imagery such as photographs, satellite images, etc., or a combination thereof).

In step 303, the analysis module 203 determines at least one pickup point for the ride hailing service based on the location of a user of the ride hailing service. In one embodiment, the analysis module 203 determines the pickup point based on a nearest navigable road link to the at least one entry-exit point of the POI. In most instances, the nearest navigable road link should be a road link that enables a user to reach a ride hailing vehicle 115 (e.g., vehicle 115a) within a few steps from the entry-exit point (e.g., exit 113a).

In step 305, the calculation module 207 calculates a path from the location (e.g., the location of the user) to the at least one pickup point with respect to a step count, wherein the step count indicates an estimated number of steps to be taken by the user to reach the at least one pickup point. In one embodiment, the path and/or the estimated number of steps is based on indoor map data, historic human traffic data, or a combination thereof associated with the POI. By way of example, the indoor map data, the historic human traffic data, or the combination thereof may be stored in or accessible to the calculation module 207 via the geographic database 121. In one instance, the calculation module 207 calculates the path from the location of the user through the at least one entry-exit point to the ride hailing service pickup point. By way of example, in some instances, the user may be unable to access a ride hailing vehicle immediately outside of or adjacent to the POI (e.g., a user may need to walk to a designated drop off/pickup zone). In one embodiment, the analysis module 205 determines a recommended entry-exit point from among the available entry-exit points based on a minimum number of the step count.

In one embodiment, the data collection module 203 determines one or more physical attributes, average walking data, or a combination thereof of the user of the ride hailing service, wherein the estimated number of steps is based on the one or more physical attributes, the average walking data, or the combination thereof. By way of example, the calculation module 207 may calculate the path from the location to the pickup point based on an estimated number of steps consistent with one or more of the user's physical attributes, historic walking data, or a combination thereof. In other words, the estimated number of steps is based on the specific user and not objective data (e.g., indoor map data, historic human traffic data, etc.). In one instance, the one or more physical attributes may include height, weight, age, gender, heartrate pulse, sweat rate or perspiration level, eye movement, or any characteristic (e.g., a temporary or a permanent disability) that make the user's estimated number of steps inconsistent with the objective data. In one instance, the one or more physical attributes may be determined by the communication module 209 (e.g., based on a user input with an application 107). In another instance, the data collection module 207 may access the information or data stored in or accessible via the geographic database 121.

In step 307, the communication module 209 provides a representation of the step count. In one embodiment, the communication module 209 provides the representation in a user interface of a ride hailing service. By way of example, the user interface may be an application 107 (e.g., a mapping application, a navigation application, a ride hailing service booking or reservation application, etc.) of a UE 101 (e.g., a mobile device, an embedded navigation system, etc.). In one instance, a user inside of the POI (e.g., a shopping mall) may view the representation via a mobile device (e.g., a smartphone) and/or a driver of a ride hailing vehicle may view the representation via a mobile device, embedded navigation system, or a combination thereof. In one embodiment, the representation includes the path, the recommended entry-exit point, the estimated number of steps, an estimated arrival time, or a combination thereof. By way of example, the representation may let the user know that the recommended entry-exit point will take the user approximately 10 minutes to reach and, therefore, the user should select a ride hailing vehicle 115 (if more than one vehicle 115 is available) that is likely to be at the corresponding pickup point within that time frame. At or about the same time, the representation may let a ride hailing service (e.g., an operator or a driver) know that a user is approximately 10 minutes away from the ride hailing pickup point. In one instance, the operator can then assign a ride hailing service vehicle 115 that is the best position to pick up the user at that time (e.g., with minimal wait and/or inconvenience) or the driver of a ride hailing vehicle 115 may individually decide to pick up the user much like a traditional taxi approach.

FIG. 4 is a flowchart of a process for determining a ride hailing pickup point at a POI based on a change in user step count information or traffic, according to one embodiment. In various embodiments, the routing platform 109 and/or the modules 201-209 may perform one or more portions of the process 400 and may be implemented in, for instance, a chip set including a processor and a memory as shown in FIG. 8. As such, the routing platform 109 and/or modules 201-209 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps. In one embodiment, the process 400 describes additional steps that can be performed in combination with the process 300 described above.

In step 401, the analysis module 205 determines a change in the user's estimated number of steps, wherein the path is calculated further with respect to the change. By way of example, the analysis module 205 may determine based on location data (e.g., GPS data) derived from a UE 101 that a user is walking towards the ride hailing pickup point but then for some reason (intentional or unintentional) decides to walk in another direction. For example, a user in airport terminal may intentionally decide to change their path to use a restroom before being picked up. Alternatively, the same user may be talking on her or his mobile device and unintentionally changes their path without noticing. Consequently, in one embodiment, the calculation module 207 can calculate or recalculate in real-time or substantially real-time the path from the location to the pickup point for the ride hailing service based on the change. In one instance, wherein the disparity between the estimated number of steps and the new estimated number of steps exceeds a certain threshold, a ride hailing service operator (e.g., a driver) can decide whether to wait or to move on to another pickup or a ride hailing service operator can decide whether to assign a new ride hailing service vehicle 115 to the pickup to minimize delay and inconvenience.

In step 405, the data collection module 203 determines a level of pedestrian traffic within a POI, a level of vehicular traffic proximate to the POI, or a combination thereof, wherein the path is calculated further with respect to the traffic. In one embodiment, the data collection module 207 can determine the levels of pedestrian traffic and vehicular traffic based on historic information, patterns, or data sets stored in or accessible via the geographic database 121. In another instance, the data collection module 207 can determine the levels based on location data (e.g., GPS data) associated with a UE 101 (e.g., a mobile device, an embedded navigation system, etc.). By way of example, there may be multiple users walking through a POI with access to or using a UE 101 (e.g., a mobile phone or a smartphone). In addition, in instances where a ride hailing vehicle 115 does not have an embedded navigation system, the driver of the vehicle 115 may still have access to or be using a UE 101 (e.g., a mobile phone or a smartphone). In one embodiment, the data processing module 201 can determine that the pedestrian traffic within the POI is indicative of congestion and may adversely affect the estimated number of steps to be taken by the user to reach the pickup point, potentially causing both the user and the ride hailing service operator inconvenience and delay. Similarly, the data processing module 201 can determine that the vehicular traffic proximate to the POI is indicative of congestion and may adversely affect the ride hailing vehicle 115's estimated arrival time at the ride hailing pickup point, potentially causing both the user and the ride hailing service operator inconvenience and delay. Consequently, as in step 403, in one embodiment, the calculation module 207 can calculate or recalculate in real-time or substantially real-time the path from the location to the pickup point for the ride hailing service based on the traffic. In one instance, wherein the disparity between the estimated number of steps and the new estimated number of steps exceeds a certain threshold, a ride hailing service operator (e.g., a driver) can decide whether to wait or to move on to another pickup or a ride hailing service operator can decide whether to assign a new ride hailing service vehicle 115 to the pickup to minimize delay and inconvenience caused by the internal pedestrian traffic. Similarly, in one embodiment, wherein the disparity between the estimated vehicle 115 arrival time and the new estimated arrival time exceeds a certain threshold, a user can decide whether to wait or to look for a new ride hailing vehicle to minimize delay and inconvenience caused by the external traffic.

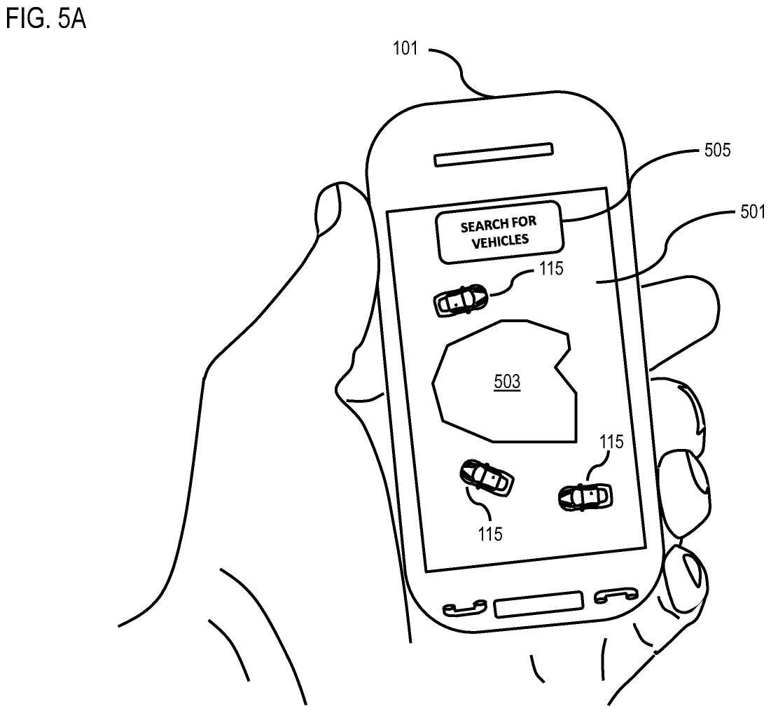

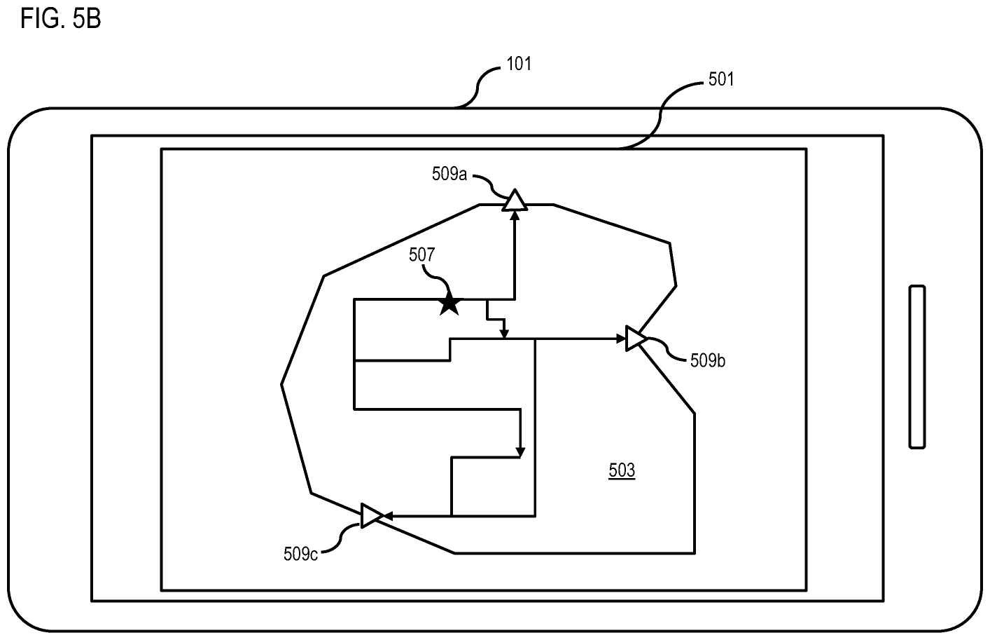

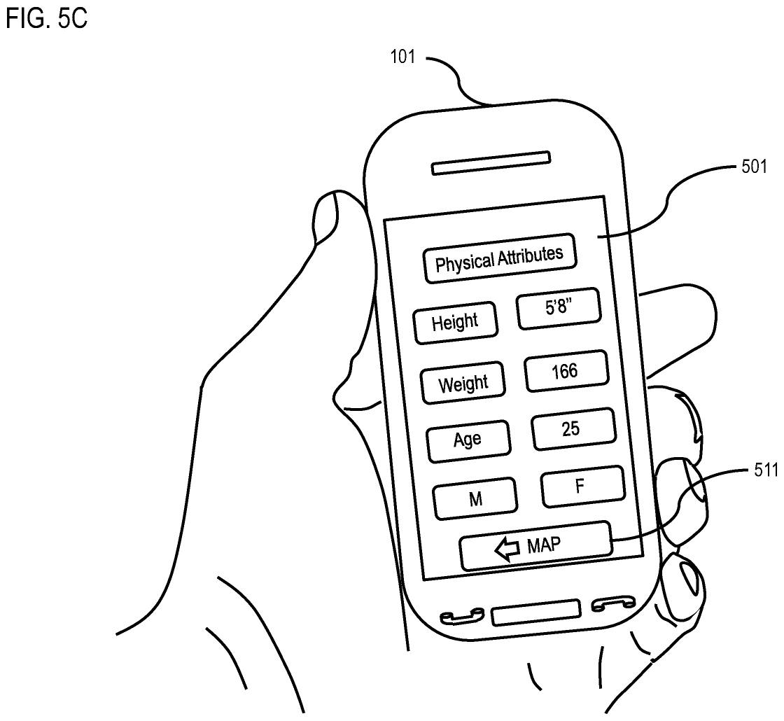

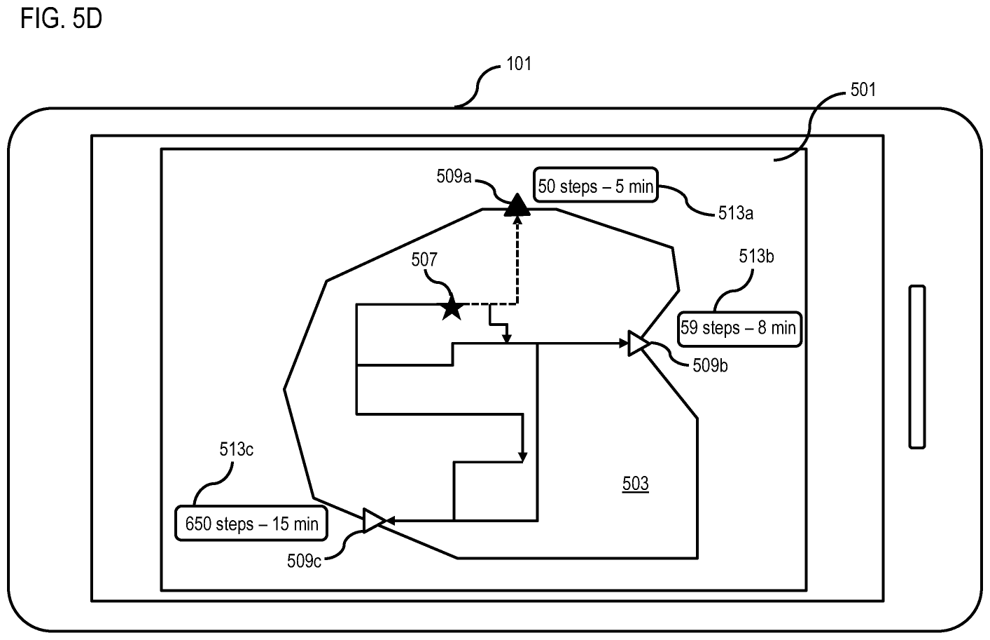

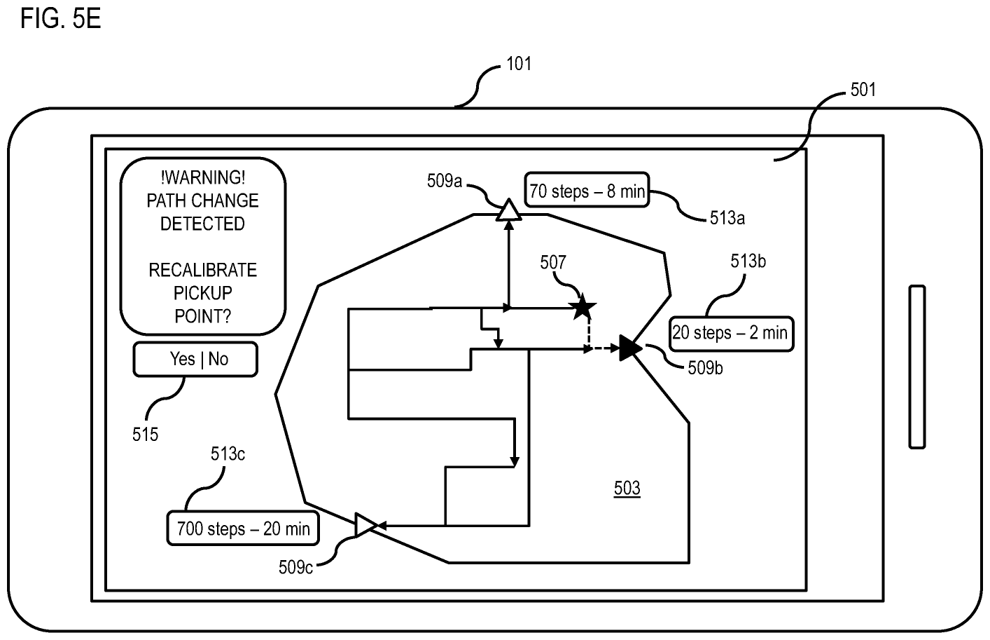

FIGS. 5A through 5E are diagrams of example location-based user interfaces for determining a ride hailing pickup point at a POI that minimizes wait time based on step count information, according to one embodiment. In this example, a location-based UI 501 (e.g., a ride hailing booking or reservation application) is generated for a UE 101 (e.g., a mobile device) that can assist a user to book a ride hailing vehicle 115 (e.g., a driven cab or an autonomous taxi) to take them from the POI 503 (e.g., a shopping mall) home. For example, the user may have multiple shopping bags and, therefore, could benefit from the convenience of being driven home as opposed to walking or taking public transportation. At the same time, the user also wants to avoid waiting too long at the POI entry-exit point while holding her or his shopping bags (e.g., for safety and/or privacy concerns).

Referring to FIG. 5A, in one embodiment, the UI 501 includes an input 505 (e.g., “search for vehicles”) to initiate a search for a ride hailing service and/or one or more ride hailing vehicles 115 (e.g., driven taxis and/or autonomous vehicles) in the vicinity of the POI 503. As described above, in many instances, the user may not be familiar with the POI and/or may not be certain as to where the entry-exits points of the POI are located, or more importantly, which one of the one or more entry-exit points of the POI the user should designate as the ride hailing pickup point to minimize her or his wait time before being picked up by a ride hailing vehicle 115.

In one embodiment, the system 100 first determines the location of the user (e.g., represented by the symbol 507) relative to the entry-exit points of the POI 503 (e.g., points 509a, 509b, and 509c) based on the initiation of the search for a ride hailing service, as depicted in FIG. 5B. In this instance, the distances between the user's location 507 and the entry-exit points 509a and 509b may appear nominal to a user whereas the distance between the user's location 507 and the entry-exit point 509c appears to the user substantially further and/or inconvenient to reach in a short period of time.

In one embodiment, the system 100 next determines the step count information between the location 507 and the entry-exit points 509a-509c. In one instance, the system 100 can determine the step count information based on generalized information (e.g., indoor map information, historic human traffic data, or a combination thereof); real-time or substantially real-time location data (e.g., GPS data); and/or user-based data (e.g., one or more physical attributes, average walking data, or a combination thereof of the user of the UE 101). In one embodiment, the system 100 can determine the step count information depending on the level of wireless connectivity or coverage within the POI 503, the level of accuracy required, or a combination thereof. For example, in some situations, it may be relatively clear to a user which entry-exit point requires the fewest number of steps to reach and, therefore, the system 100 may only use generalized historic data. This may be advantageous in terms of requiring minimal time and/or computational resources to recommend an entry-exit point to a user. However, in other instances, such as in the case of entry-exit points 509a and 509b, the system 100 may access historical probe data (e.g., stored in the geographic database 121) or real-time or substantially real time location data associated with a UE 101 (e.g., a mobile device). By way of example, the system 100 can determine that based on real-time or historic location data that while the paths between the user's location 507 and the entry-exit points 509a and 509b appear nearly the same; pedestrian traffic between the user's location 507 and the entry-exit point 509c may require the user to take more steps than she or he would if she or he was walking to entry-exit point 509a.

In one embodiment, the system 100 can also determine the step count information based on one or more physical attributes of the user. For example, the system 100 can determine a user's gender, height, weight, age, etc. (i.e., any physical attributes that may affect the user's ability to walk from one point to another) based on information or data stored in or accessible via the geographic database 121. In one instance, the system 100 can generate the UI 501 such that a user can input or enter the information once she or he has initiated the search for a ride hailing service, as depicted in FIG. 5C. In one embodiment, the UI 501 includes an input 511 to enable the user to return to the map portion of the UI 501 once the one or more physical attributes have been entered via the UI 501.

In one embodiment, the system 100 designates one of the entry-exit points 509a-509c as the ride hailing pickup point, as depicted in FIG. 5D. In this instance, the system 100 graphically designates the entry-exit point 509a as the ride hailing pickup point by modifying the route or path between the user's location 507 and the entry-exit point 509a and by shading the entry-exit symbol 509a. In one embodiment, the system 100 can also provide the step information, an estimated arrival time, or a combination thereof, as depicted in the windows 513a, 513b, and 513c. In this example, the system 100 determines that the entry-exit point 509a is 50 steps or 5 minutes from the user location 507, the entry-exit point 509b is 59 steps or 8 minutes from the user location 507, and the entry-exit point 509c is 650 steps or 15 minutes from the user location 507. In one embodiment, a user can interact with the windows 511 to learn or to change the information that the system 100 is using to determine the step count information. For example, by default, the system 100 may determine the step count information based on historic human traffic data, but the user has learned over the course of time that she or he is considerably slower or faster than the such averages and, therefore, may want to set the system 100 to determine the step count information based on the user's own average walking data or location data. In one embodiment, the system 100 can then share or transmit the ride hailing pickup point (e.g., point 509a) generally with one or more ride hailing services or directly with one or more ride hailing vehicles 113 within the vicinity of the POI 503 to optimize both the user wait time and any possible wait times on the part of the one or more ride hailing vehicles 113.

In one embodiment, the system 100 can determine a change in the user step count information based on location data (e.g., GPS data) associated with the UE 101. For example, the system 100 can determine that the user has exceeded the 50 steps that the system 100 estimated it would have taken the user to reach the entry-exit point 509a. In one embodiment, the system 100 can visually prompt or notify the user of the change via the UI 501 (e.g., “Warning! path change detected”), as depicted in FIG. 5E. In one instance, the system 100 may also cause the UI 101 to vibrate or make a sound to alert the user of the deviation. As described above, in some instances, the deviation on the part of the user may be intentional, but in other instances, the change may have been unintentional. For example, the user may have thought that they were familiar enough with the POI that once the entry-exit point was designated by the system 100, they did not need to rely on the UI 501 to get to the entry-exit point 509a. However, despite their best intentions, the user managed to walk off the intended path. In one instance, the user may have been simply attempting to save battery life.

In one embodiment, the system 100 can ask the user via the UI 501 whether she or he wants the system 100 to designate another entry-exit point as the ride hailing pickup point (e.g., “recalibrate pickup point”?). In one instance, the user may still be uncertain where the entry-exit points of the POI 503 are located and/or which entry-exit point of the POI 503 is the most convenient in terms of the least wait time for pickup. In one instance, a user can confirm the recalibration through an interaction with the input 515 (e.g., a touch, a gesture, a voice command, etc.). In one embodiment, the system 100 can present the updated step count information and estimated arrival time to the user via the UI 501. Further, in one instance, the system 100 can share or transmit the new ride hailing pickup point (e.g., 509b) to the one or more ride hailing vehicles 115 previously contacted so that the ride hailing service operator can decide whether to wait based on the new ride hailing pickup point, the new estimated arrival time, or a combination thereof or whether to move on to another pickup. In one embodiment, wherein the disparity between the estimated arrival times exceeds a certain threshold (e.g., 5-10 minutes), the system 100 can share or transmit the new ride hailing pickup point 509b with a new batch of one or more ride hailing service vehicles 115 (e.g., if the original vehicles 115 are no longer in the vicinity).

Returning to FIG. 1, in one embodiment, the UEs 101 can be associated with any user within or nearby a POI that is accessible to a ride hailing service (e.g., a cab), or with any user or person within a vehicle 115 (e.g., a driver or a passenger of an autonomous or semi-autonomous vehicle). By way of example, the UEs 101 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 101 can support any type of interface to the user (such as “wearable” circuitry, etc.). In one embodiment, the vehicles 115 may have cellular or wireless fidelity (Wi-Fi) connection either through the inbuilt communication equipment or from a UE 101 associated with the vehicles 115. Also, the UEs 101 may be configured to access the communication network 111 by way of any known or still developing communication protocols. In one embodiment, the UEs 101 may include the routing platform 109 to determine a ride hailing pickup point at a POI based on step count information.

In one embodiment, the UEs 101 include device sensors 105 (e.g., a front facing camera, a rear facing camera, GPS sensors, multi-axial accelerometers, height sensors, tilt sensors, moisture sensors, pressure sensors, wireless network sensors, etc.) and applications 107 (e.g., mapping applications, ride hailing booking or reservation applications, routing applications, guidance applications, navigation applications, etc.). In one example embodiment, the GPS sensors 105 can enable the UEs 101 to obtain geographic coordinates from satellites 123 for determining current or live location and time (e.g., within a POI). Further, a user location within a POI may be determined by a triangulation system such as A-GPS, Cell of Origin, or other location extrapolation technologies when cellular or network signals are available. In one embodiment, the location of the UEs 101 can be determined within a POI based on one or more WiFi routers positioned throughout the POI.

In one embodiment, the routing platform 109 performs the process for determining a ride hailing pickup point at a POI based on step count information as discussed with respect to the various embodiments described herein. In one embodiment, the routing platform 109 can be a standalone server or a component of another device with connectivity to the communication network 111. For example, the component can be part of an edge computing network where remote computing devices (not shown) are installed along or within proximity of an intended destination (e.g., a city center).

In one embodiment, the routing platform 109 has connectivity over the communication network 111 to the services platform 125 (e.g., an OEM platform) that provides one or more services 127a-127n (also collectively referred to herein as services 127) (e.g., mapping/routing services). By way of example, the services 127 may also be other third-party services and include mapping services, navigation services, ride hailing reservation or booking services (e.g., booking a ride hailing vehicle 115), guidance services, notification services, social networking services, content (e.g., audio, video, images, etc.) provisioning services, application services, storage services, contextual information determination services, location-based services, information-based services (e.g., weather, news, etc.), etc. In one instance, the services 127 provide representations of each user (e.g., a profile), his/her social links, and a variety of additional information (e.g., one or more physical attributes). In one instance, the services 127 can allow users to share location information, activities information, POI related information, contextual information, and interests within their individual networks, and provides for data portability.

In one embodiment, the content providers 129a-129n (also collectively referred to herein as content providers 129) may provide content or data (e.g., navigation-based content such as destination information, routing instructions, estimated times of arrival, POI related data such as indoor maps and entry-exit points, historical human traffic data; ride hailing service booking or contact information; etc.) to the UEs 101, the applications 107, the routing platform 109, the vehicles 115, the geographic database 121, the services platform 125, and the services 127. The content provided may be any type of content, such as map content, contextual content, audio content, video content, image content (e.g., exterior images of a POI), etc. In one embodiment, the content providers 129 may also store content associated with the UEs 101, the applications 107, the routing platform 109, the vehicles 115, the geographic database 121, the services platform 125, and/or the services 127. In another embodiment, the content providers 129 may manage access to a central repository of data, and offer a consistent, standard interface to data, such as a repository of the geographic database 121.

By way of example, as previously stated the vehicle sensors 117 may be any type of sensor. In certain embodiments, the vehicle sensors 117 may include, for example, a GPS sensor for gathering location data, a network detection sensor for detecting wireless signals or receivers for different short-range communications (e.g., Bluetooth, Wi-Fi, light fidelity (Li-Fi), near field communication (NFC) etc.), temporal information sensors, a camera/imaging sensor for gathering image data, velocity sensors, and the like. In another embodiment, the vehicle sensors 117 may include sensors (e.g., mounted along a perimeter of the vehicle 115) to detect the relative distance of the vehicle 115 from lanes or roadways, the presence of other vehicles 115, pedestrians, animals, traffic lights, road features (e.g., curves) and any other objects, or a combination thereof. In one scenario, the vehicle sensors 117 may detect weather data, traffic information, or a combination thereof. In one example embodiment, the vehicles 115 may include GPS receivers 117 to obtain geographic coordinates from satellites 123 for determining current or live location and time. Further, the location can be determined by a triangulation system such as A-GPS, Cell of Origin, or other location extrapolation technologies when cellular or network signals are available.

The communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the routing platform 109 may be a platform with multiple interconnected components. By way of example, the routing platform 109 may include multiple servers, intelligent networking devices, computing devices, components and corresponding software for determining a ride hailing pickup point at a POI based on step count information. In addition, it is noted that the routing platform 109 may be a separate entity of the system 100, a part of the services platform 125, the services 127, or the content providers 129.

In one embodiment, the geographic database 121 stores information regarding indoor map information, historic human traffic data, or a combination thereof associated with a POI. In one instance, the geographic database 121 also stores information regarding one or more physical attributes, average walking data (e.g., a mobility graph), or a combination thereof of a user of a user device (e.g., a mobile phone or a smartphone). In one embodiment, the geographic database 121 stores data associated with vehicular traffic proximate to a POI, ride hailing service booking and/or contact information, etc. The information may be any of multiple types of information that can provide means for determining a ride hailing pickup point at a POI based on step count information. In another embodiment, the geographic database 121 may be in a cloud and/or in a UE 101, a vehicle 115, or a combination thereof.

By way of example, the UEs 101, the applications 107, the routing platform 109, the vehicles 115, the geographic database 121, the satellites 123, the services platform 125, the services 127, and the content providers 129 communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

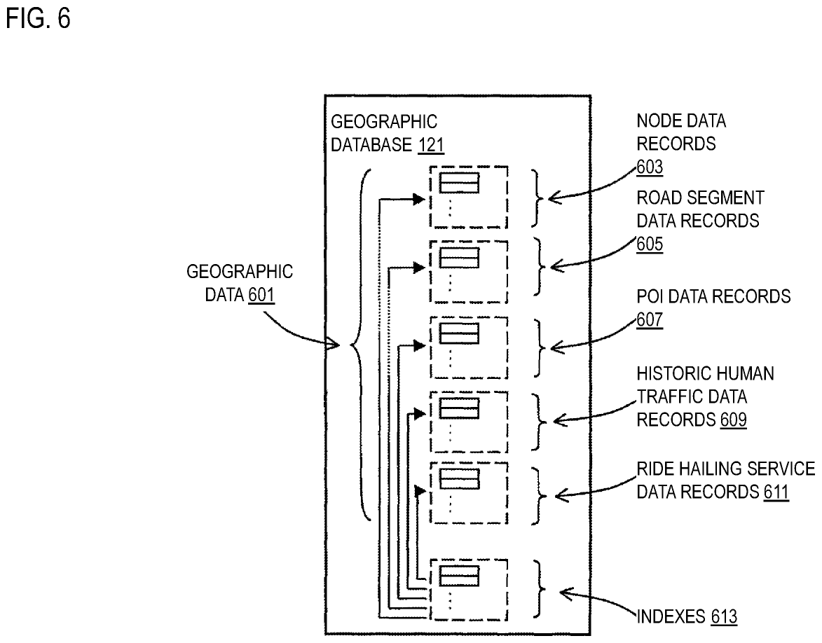

FIG. 6 is a diagram of a geographic database 121, according to one embodiment. In one embodiment, geographic database 121 includes geographic data 601 used for (or configured to be compiled to be used for) mapping and/or navigation-related services, such as for step counting to access a POI pickup point, video odometry based on mapped features, e.g., lane lines, road markings, signs, etc.

In one embodiment, geographic features, e.g., two-dimensional or three-dimensional features, are represented using polygons, e.g., two-dimensional features, or polygon extrusions, e.g., three-dimensional features. For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in geographic database 121.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes, e.g., used to alter a shape of the link without defining new nodes.

“Oriented link”—A link that has a starting node (referred to as the “reference node”) and an ending node (referred to as the “non-reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary, e.g., a hole or island. In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In geographic database 121, overlapping geographic features are represented by overlapping polygons. When polygons overlap, the boundary of one polygon crosses the boundary of the other polygon. In geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 121 includes node data records 603, road segment or link data records 605, POI data records 607, historic human traffic data records 609, ride hailing service data records 611, and indexes 613, for example. More, fewer or different data records can be provided. In one embodiment, additional data records (not shown) can include cartographic (“carto”) data records, routing data, and maneuver data. In one instance, the additional data records (not shown) can include user mobility pattern data. In one embodiment, the indexes 613 may improve the speed of data retrieval operations in geographic database 121. In one embodiment, the indexes 613 may be used to quickly locate data without having to search every row in geographic database 121 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes, an estimated time of arrival, or a combination thereof (e.g., an estimated time of arrival of a ride hailing vehicle 115 at a POI pickup point). The node data records 603 are end points corresponding to the respective links or segments of the road segment data records 605. The road link data records 605 and the node data records 603 represent a road network, such as used by vehicles, cars, and/or other entities. Alternatively, the geographic database 121 can contain path segment and node data records or other data that represent pedestrian paths, bicycle paths, or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 607. In one instance, the POI data records 607 can include indoor map information, entry-exit point information (e.g., numbers and locations of entry-exit points), historic pedestrian traffic flows within the POI, historic vehicular traffic flows proximate to the POI, opening and closing times of a POI, etc.

In one embodiment, the indoor map information is created from high-resolution 3D mesh or point-cloud data generated, for instance, from LiDAR. The 3D mesh or point-cloud data are processed to create 3D representations of interior pathways, hallways, corridors, etc. of a POI at centimeter-level accuracy for storage in the POI data records 607.

In one embodiment, the geographic database 121 can also include historic human traffic data records 609. By way of example, the historic human traffic data records 609 may include how many steps users take (e.g., based on an average) between various locations within a POI and each entry-exit point; where or how users move throughout the POI (e.g., preferred paths); which entry-exit points are most often used by pedestrian traffic; which entry-exit points are accessible to ride hailing services; etc. In one instance, the historic human traffic records 609 may include historic information relating to one or more physical attributes (e.g., gender, height, weight, age, heartrate, etc.).

In one embodiment, the geographic database 121 can also include ride hailing service data records 611. In another embodiment, the ride hailing service data records 611 stores information relating to the one or more ride hailing services, one or more ride hailing vehicles, e.g., vehicle type, vehicle features, reservation cost information, etc. By way of example, the ride hailing services data records 611 can be associated with one or more of the node data records 603, road segment data records 605, and/or POI data records 607 to support localization and opportunistic use of the ride hailing services during navigation through a POI.

In one embodiment, geographic database 121 can be maintained by a content provider 129 in association with the services platform 125, e.g., a map developer. The map developer can collect geographic data to generate and enhance geographic database 121. There can be different ways used by the map developer to collect data. These ways can include obtaining data from other sources, such as municipalities or respective geographic authorities. In addition, the map developer can employ field personnel to travel by foot with a UE 101 within various large POIs to determine step counting information or records about them, for example. Also, remote sensing, such as aerial or satellite photography, can be used for approximating interior distances (e.g., using one or more satellites 123).

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, a UE 101, for example. The navigation-related functions can correspond to pedestrian navigation, vehicle navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for determining a ride hailing pickup point at a POI based on step count information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

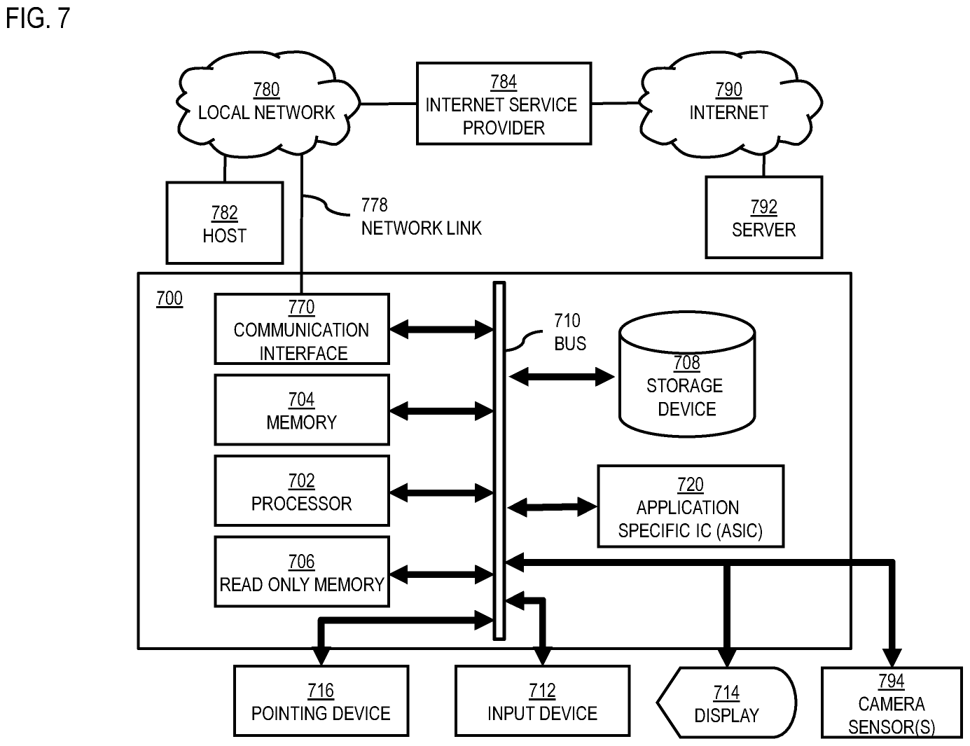

FIG. 7 illustrates a computer system 700 upon which an embodiment of the invention may be implemented. Computer system 700 is programmed (e.g., via computer program code or instructions) to determine a ride hailing pickup point at a POI based on step count information as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to determining a ride hailing pickup point at a POI based on step count information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random-access memory (RAM) or other dynamic storage device, stores information including processor instructions for determining a ride hailing pickup point at a POI based on step count information. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for determining a ride hailing pickup point at a POI based on step count information, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general, the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 111 for determining a ride hailing pickup point at a POI based on step count information.

The term non-transitory computer-readable medium is used herein to refer to any medium that participates in providing information to processor 702, including instructions for execution. Such a medium may take many forms, including, but not limited to, non-volatile media, volatile media and transmission media. Non-volatile or non-transitory media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

In one embodiment, a non-transitory computer-readable storage medium carrying one or more sequences of one or more instructions (e.g., computer code) which, when executed by one or more processors (e.g., a processor as described in FIG. 5), cause an apparatus (e.g., the vehicles 101, the UEs 105, the routing platform 109, etc.) to perform any steps of the various embodiments of the methods described herein.

FIG. 8 illustrates a chip set 800 upon which an embodiment of the invention may be implemented. Chip set 800 is programmed to determine a ride hailing pickup point at a POI based on step count information as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to determine a ride hailing pickup point at a POI based on step count information. The memory 805 also stores the data associated with or generated by the execution of the inventive steps.

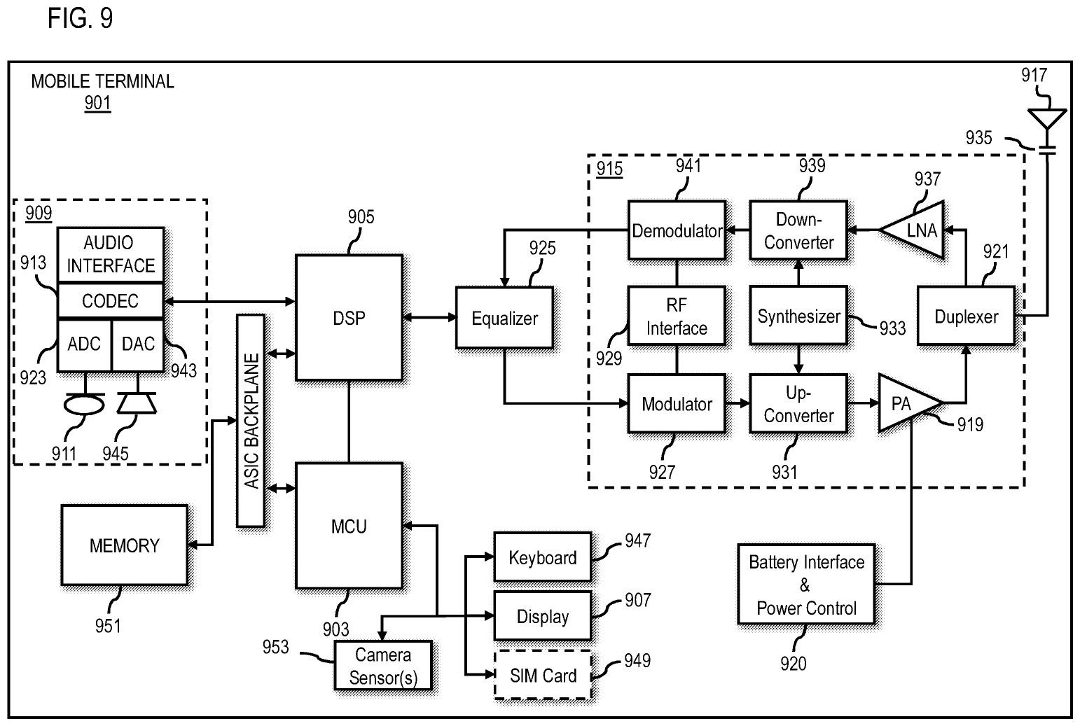

FIG. 9 is a diagram of exemplary components of a mobile terminal 901 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), WiFi, satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to determine a ride hailing pickup point at a POI based on step count information. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable non-transitory computer readable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for determining a ride hailing pickup point based on step count information comprising:
determining a location of a user of a ride hailing service;
determining at least one pickup point for the ride hailing service based on the location;
calculating a path from the location to the at least one pickup point with respect to a step count, wherein the step count indicates an estimated number of steps to be taken by the user to reach the at least one pickup point; and
providing a representation of the step count.

2. The method of claim 1, further comprising:
determining that the location of the user is inside a point of interest (POI);
determining at least one entry-exit point of the POI,
wherein the path is calculated from the location through the at least one entry-exit point to the at least one pickup point.

3. The method of claim 2, wherein the path is further based on indoor map data, historic human traffic data, or a combination thereof associated with the POI.

4. The method of claim 2, wherein the at least one pickup point is determined based on a nearest navigable road link to the at least one entry-exit point.

5. The method of claim 2, further comprising:
determining a recommended entry-exit point from the at least one entry-exit point based on a minimum number of the step count.

6. The method of claim 5, wherein the representation of the step count includes the path, the recommended entry-exit point, the estimated number of steps, an estimated arrival time, or a combination thereof.

7. The method of claim 1, further comprising:
determining one or more physical attributes, historic walking data, or a combination thereof of the user,
wherein the estimated number of steps is based on the one or more physical attributes, the average walking data, or the combination thereof.

8. The method of claim 1, further comprising:
determining a change in the estimated number of steps,
wherein the path is calculated further with respect to the change.

9. The method of claim 1, further comprising:
determining a level of pedestrian traffic within the POI, a level of vehicular traffic proximate to the POI, or a combination thereof,
wherein the path is calculated further with respect to the traffic.

10. The method of claim 1, wherein the path comprises a pedestrian path, and wherein the representation is provided in a user interface of the ride hailing service.

11. An apparatus for determining a ride hailing pickup point based on step count information comprising:
at least one processor; and
at least one memory including computer program code for one or more programs,
the at least one memory and the computer program code configured to, with the at least one processor, cause the apparatus to perform at least the following,
determine a location inside a point of interest (POI) of a user of a ride hailing service;
determine at least one pickup point for the ride hailing service based on the location;
calculate a path from the location to the at least one pickup point with respect to a step count, wherein the step count indicates an estimated number of steps to be taken by the user to reach the at least one pickup point; and
determine a recommended entry-exit point of the POI based on a minimum number of the step count.

12. The apparatus of 11, wherein the path is calculated from the location through the recommended entry-exit point to the at least one pickup point.

13. The apparatus of claim 11, wherein the path is further based on indoor map data, historic human traffic data, or a combination thereof associated with the POI.

14. The apparatus of claim 11, wherein the at least one pickup point is determined based on a nearest navigable road link to the recommended entry-exit point.

15. The apparatus of claim 11, wherein the representation of the step count includes the path, the recommended entry-exit point, the estimated number of steps, an estimated arrival time, or a combination thereof.

16. The apparatus of claim 11, wherein the apparatus is further caused to:
determine one or more physical attributes, historic walking data, or a combination thereof of the user,
wherein the estimated number of steps is based on the one or more physical attributes, the average walking data, or the combination thereof.

17. The apparatus of claim 11, wherein the path comprises a pedestrian path.

18. A non-transitory computer-readable storage medium for determining a ride hailing pickup point based on step count information carrying one or more sequences of one or more instructions which, when executed by one or more processors, cause an apparatus to perform:
determining a location of a user of a ride hailing service;
determining at least one pickup point for the ride hailing service based on the location;
calculating a pedestrian path from the location to the at least one pickup point with respect to a step count, wherein the step count indicates an estimated number of steps to be taken by the user to reach the at least one pickup point; and
providing a representation of the step count in a user interface of the ride hailing service.

19. The non-transitory computer-readable storage medium of claim 18, wherein the apparatus if further caused to:
determine that the location of the user is inside a point of interest (POI);
determine at least one entry-exit point of the POI,
wherein the pedestrian path is calculated from the location through the at least one entry-exit point to the at least one pickup point.

20. The non-transitory computer-readable storage medium of claim 18, wherein the pedestrian path is further based on indoor map data, historic human traffic data, or a combination thereof associated with the POI.
